(19) United States
(12) Patent Application Publication
(10) Pub. No.: US 2002/0074925 A1
(43) Pub. Date: Jun. 20, 2002

(54) Color picture tube free from deviation of convergence

(75) Inventor: Akira Nakanishi, Shiga (JP)

Correspondence Address: YOUNG & THOMPSON, 745 SOUTH 23RD STREET 2ND FLOOR, ARLINGTON, VA, 22202

(73) Assignee: NEC Corporation,

(21) Appl. No.: 09/978,625

(22) Filed: Oct. 18, 2001

(30) Foreign Application Priority Data
Oct. 19, 2000 (JP) 2000-319198 PAT.

(51) Int. Cl. H01J 29/50

(52) U.S. Cl. 313/409; 313/441; 313/414

(57) ABSTRACT

A color picture tube has an electron gun assembly directed to a shadow mask spaced from a fluorescent screen by a predetermined distance in the bulb thereof, and a high voltage is supplied through a conductive layer formed on the inner surface of the bulb and a bulb spacer to an accelerating electrode of the electron gun assembly, wherein the contact resistance between the conductive layer and the bulb spacer is reduced to be equal to or less than 1 kilo-ohms so that the accelerating electrode is free from electrical influence of parabola voltage applied to a focusing electrode, whereby an undesirable lens is prevented and, accordingly, the electron beams are not deviated from the target trajectories.

### FIELD OF THE INVENTION

This invention relates to a cathode ray tube and, more particularly, to a color picture tube for producing a full-color image on the screen thereof.

### DESCRIPTION OF THE RELATED ART

The color picture tube is used for various purposes. The color picture tube is, by way of example, incorporated in a computer system, and character images and/or picture is produced thereon. The color picture tube forms a part of a high quality television receiver, and moving images are produced thereon.

FIG. 1 illustrates a typical example of the color picture tube, which is designated by reference numeral 21. The prior art color picture tube 21 includes a glass panel 22 and a glass funnel 23. The glass panel 22 is adhered to the glass funnel 23 by means of glass frit 24, and the glass panel 22 and the glass funnel 23 are assembled into a bulb 25.

The prior art color picture tube 21 further includes a fluorescent screen 26 and a shadow mask structure, and the shadow mask structure consists of a shadow mask 27 and a mask frame 28. Florescent dots for red light, fluorescent dots for green light and fluorescent dots for blue light are arranged on the fluorescent screen 26, and a large number of through-holes are formed in the shadow mask 27. The three kinds of fluorescent substance may be formed into stripes on the fluorescent screen 26. The shadow mask 27 is spaced from the fluorescent screen 26 by a predetermined distance, and is welded to the mask frame 28. The mask frame 28 is assembled with the glass panel 22 by means of pins 29.

The glass funnel 23 has a neck portion 30 and a cone portion 32. A conductive layer 33 extends on the inner surface of the glass funnel 23 from the neck portion 30 to the cone portion 32. The conductive layer 33 is formed of graphite. An electron gun assembly 31 is accommodated in the neck portion, and three electron beams are radiated from the electron gun assembly 31 through the shadow mask 27 toward the fluorescent screen 26. A bulb spacer 34 is elastically pressed against the conductive layer 33, and the acceleration electrode is electrically connected through the bulb spacer 34 to the conductive layer 33. A deflecting yoke 35 is provided at the boundary between the neck portion 30 and the cone portion 32, and deflects the electron beams.

A high voltage is applied from an external power source (not shown) through the conductive layer 33 to the acceleration electrode. Then, the electron beams are accelerated. The deflecting yoke 35 deflects the electron beams so as to sweep the fluorescent screen 26 with the electron beams. When the dots of the three kinds of fluorescent substance are swept with the electron beams, respectively, the red light, the green light and blue light are emitted from the dots, and a full-color image is produced on the fluorescent screen 26.

An in-line type electron gun assembly radiates the three electron beams arranged in the horizontal scanning direction. The in-line type electron gun assembly is incorporated in the prior art color picture where a self-convergence magnetic field is to be created for improving the convergence in the peripheral area of the screen.

The color picture tube is required to have high brightness and high resolution. In order to achieve the high brightness, research and development efforts have been made on the fluorescent substance so as to make the fluorescent screen 26 emit a large amount of light, and the shadow mask 27 has been improved so as to enhance the penetrating ratio. To increase the intensity of the electron beam is also conducive to the high brightness, and the operating voltage is increased. An improvement in withstanding voltage is to be required.

On the other hand, the following technologies have been developed in order to achieve the high resolution. A focusing electrode is multiplied into a multi-stage focusing electron gun. The electron gun is improved in the focusing capability. Since the in-line self-convergence system makes the deflecting magnetic field deformed, the electron beams are expanded in the peripheral area of the fluorescent screen 26, and, accordingly, the electron beams have a wide cross section. This results in reduction of the resolution. In order to keep the electron beams narrow in the peripheral area, an alternating current voltage, which is hereinbelow referred to as “parabola voltage”, is superimposed on the focusing voltage in synchronism with the horizontal scanning. The electron beams keep the cross sections in the peripheral area as narrow as those in the central area, and the resolution is improved.

FIG. 2 illustrates the electron gun assembly 31 incorporated in the prior art color picture tube. The electron gun assembly 31 includes a heater 36, a cathode 37, the first grid electrode G1, the second grid electrode G2, the third grid electrode G3, the fifth grid electrode G5, the sixth grid electrode G6 and a shield case 38 connected to the sixth grid electrode G6. A heating voltage is applied to the heater 36. The first grid electrode G1 is grounded. The second grid electrode G2 is applied with hundreds volts, and thousands volts are applied to the third grid electrode G3. A composite voltage, i.e., a focusing voltage superimposed on the parabola voltage is applied to the fifth grid electrode G5, and the composite voltage is thousands volts. A high voltage between 20 kilovolts and 30 kilovolts is applied through a high voltage input terminal 39, the conductive layer 33, the bulb spacer 34 and the shield case 38 to the sixth grid electrode G6. The high voltage input terminal 39 is provided in the funnel portion 23. The voltage applied to the third and fifth grid electrodes G3/G5 is a middle voltage, which is 20% to 30% of the high voltage applied to the sixth grid G6.

The prior art color picture tube thus arranged is fabricated as follows. First, the electron gun assembly 31 is inserted into the bulb 25, and is fixed thereto. The bulb 25 is connected to an evacuating system (not shown) at a gas outlet port, and is heated to a predetermined temperature. The evacuating system is activated, and the gas is evacuated from the inner space of the bulb 25. The electrodes of the electron gun assembly 31 is heated through a high frequency heating technique in the later stage of the evacuation so as to carry out an outgassing from the electrodes. A certain voltage is applied to the heater 36, and heat is radiated from the heater 36 to the cathode 37. Thus, the cathode 37 is heated. The cathode 37 was coated with carbonate of alkaline earth metal. The carbonate of alkaline earth meal is decomposed, and becomes oxide.

Upon completion of the evacuation, the gas outlet port is melted down with heat, and the bulb 25 is separated from the evacuating system. Thus, the electron gun assembly 31 is sealed in the bulb 25.

Though not shown in FIGS. 1 and 2, gettering substance was provided in the bulb 25. The gettering substance is heated. Then, the gettering substance is dispersed inside the bulb 25, and forms a gettering layer on the inner surface of the bulb 25. Residual gaseous mixture is absorbed into the gettering layer. Thus, the gettering layer keeps the inner space of the bulb 25 in high vacuum. The gettering is followed by a stabilizing and a knocking. The cathode 37 is activated through the stabilizing. The electrodes forming the parts of the electron gun assembly 31 usually have rough surfaces and burrs, and a source of stray-emission such as barium compound is left on the rough surfaces. A large number of small bumps are observed on the rough surface. The electrodes are shaped through a press work, and the burrs were produced during the press work. The small bumps, burrs and the source of stray-emission are removed through the knocking by applying a high voltage.

A problem is encountered in the prior art color picture tube in that the deviation of convergence take place in synchronism with the parabola voltage superimposed on the focusing voltage, and, then, unexpected fluorescent dots emit the light.

### SUMMARY OF THE INVENTION

It is therefore an important object of the present invention to provide a color picture tube, an electron gun assembly of which exactly makes fluorescent screen sequentially emit the light from predetermined points without the deviation of convergence.

The present inventor simulated the deviation of convergence by using an equivalent circuit, and found that the parabola voltage was undesirably superimposed on the high voltage applied at the acceleration electrode. The present inventor investigated causes of the superimposition, and found that the contact resistance between the bulb spacer and the conductive layer was causative of the superimposition.

To accomplish the object, the present invention proposes to reduce the contact resistance between a bulb spacer and a conductive layer.

In accordance with one aspect of the present invention, there is provided a color picture tube for producing visual images comprising a bulb having an inner space, a fluorescent screen attached to the bulb and producing the visual image, a shadow mask structure provided in the inner space, having plural through holes and inwardly spaced from the fluorescent screen, an electron gun assembly radiating electron beams through the plural through- holes to the fluorescent screen and including at least a focusing electrode applied with an alternating current voltage and an accelerating electrode, a bulb spacer connected at one end thereof to the accelerating electrode, and a conductive layer formed on an inner surface of the bulb, and connected to another end of the bulb spacer for supplying the high voltage to the accelerating electrode through the bulb spacer against a contact resistance equal to or less than 1 kilo-ohms.

### BRIEF DESCRIPTION OF THE DRAWINGS

The features and advantages of the color picture tube will be more clearly understood from the following description taken in conjunction with the accompanying drawings in which:

FIG. 1 is a partially cut-away side view showing the structure of the prior art color picture tube;

FIG. 2 is a view showing the arrangement of the prior art electron gun;

FIG. 3 is an equivalent circuit of a loop of a focus electrode, an accelerating electrode and a contact between a bulb spacer and a conductive layer;

FIG. 4 is an equivalent circuit of the loop from the viewpoint that only alternating current flows;

FIG. 5 is a graph showing a relation between a leakage ratio and a contact resistance between the bulb spacer and the conductive layer;

FIG. 6 is a partially cut- away side view showing the structure of a color picture tube according to the present invention;

FIG. 7 is a schematic view showing the color picture tube subjected to a knocking;

FIG. 8 is a graph showing a relation between the contact resistance and the thickness of the conductive layer;

FIG. 9 is a graph showing a relation between a parabola voltage component and the thickness of the conductive layer;

FIG. 10 is a graph showing a relation between deviation of convergence and the thickness of the conductive layer; and

FIG. 11 is a graph showing a relation between adhesion and the thickness of the conductive layer.

### DESCRIPTION OF THE PREFERRED EMBODIMENTS

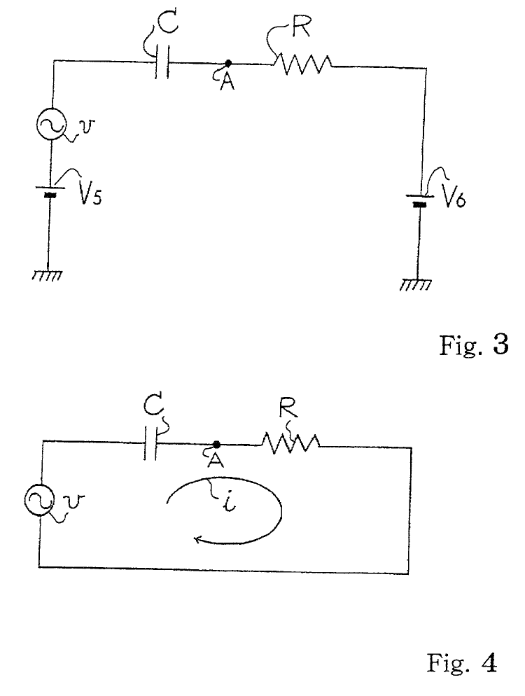

Although the deviation of convergence had been known to persons skilled in the art, it is not clear why the deviation of convergence occurred. The present inventor supposed that the parabola voltage was superimposed on the high voltage applied to the accelerating electrode for some reason, and had a doubt about the contact resistance between the bulb spacer and the conductive layer. The contact resistance had been assumed to be zero in the previous design work. The present inventor had a doubt about the assumption. The present inventor expressed the loop of a focus electrode, an accelerating electrode and a contact between a bulb spacer and a conductive layer in an equivalent circuit as shown in FIG. 3, calculated a loop current in the equivalent circuit, determined a potential drop at the contact resistance by using the loop current, and simulated influence of the contact resistance on the potential drop. The potential drop was related to the leakage of the parabola voltage. In FIG. 3, reference C was representative of electrostatic capacitance between the focus electrode and the accelerating electrode, and R stood for the resistance between the bulb spacer and the conductive layer, which was substantially equal to the contact resistance between the bulb spacer and the conductive layer. The unit of the electrostatic capacitance C was farad, i.e., F, and the unit of the resistance was ohm, i.e., Ω. The focus electrode was applied with V5, and V6 was applied to the accelerating electrode. V5 was the direct current voltage, and was, by way of example, of the order of 6 kilovolts. V6 was also direct current voltage, and was, by way of example, of the order of 25 kilovolts.

The parabola voltage v, i.e., alternating current voltage was superimposed on the direct current voltage V5. The parabola voltage v was expressed as Vm sin (ωt) where ωt was 2πf. Point A was representative of a conductive member including the accelerating electrode, a shield case and the bulb spacer. Therefore, point A was to be equal in potential level to the accelerating electrode, the shield case and the bulb spacer.

When paying the attention to the alternative current, the equivalent circuit was expressed as shown in FIG. 4. Current i flowing through the loop was expressed as

i=v/Z=(1/Z) Vm sin (ωt+Φ)=Im sin (ωt+Φ) (1)

where Φ was the phase angle and Z is the impedance of the equivalent circuit. The phase angle Φ and the impedance Z were given as

Φ=arc tan (1/ωCR) (2)

Z={R²+1/(ωC)²}^{½} (3)

The voltage VR applied between both ends of the resistor R, i.e., the voltage at point A was given as follows.

VR=i R=R (1/Z) Vm sin (ωt+Φ) (4)

The voltage VR at point A was equal to the voltage level at the accelerating electrode, the shield case and the bulb spacer. From equation (4), it was understood that the voltage level VR was varied in synchronism with the parabola voltage Vm. The maximum amplitude was (R/Z) Vm. Thus, the parabola voltage Vm was leaked to the accelerating electrode through the contact resistance.

The ratio of the maximum amplitude Vm of the parabola voltage to the maximum amplitude of the leaked voltage at the accelerating electrode was referred to as “leakage ratio”. The leakage ratio LR was expressed as

LR=(R/Z) Vm/Vm=R/Z=R/{R²+1/(ωC)²}^{½}=1/{1+1/(ωCR)²}^{½} (5)

The frequency of the parabola voltage and the electrostatic capacitance C between the focusing electrode and the accelerating electrode were assumed to be constant. Then, the leakage ratio LR was given as a function of the contact resistance R.

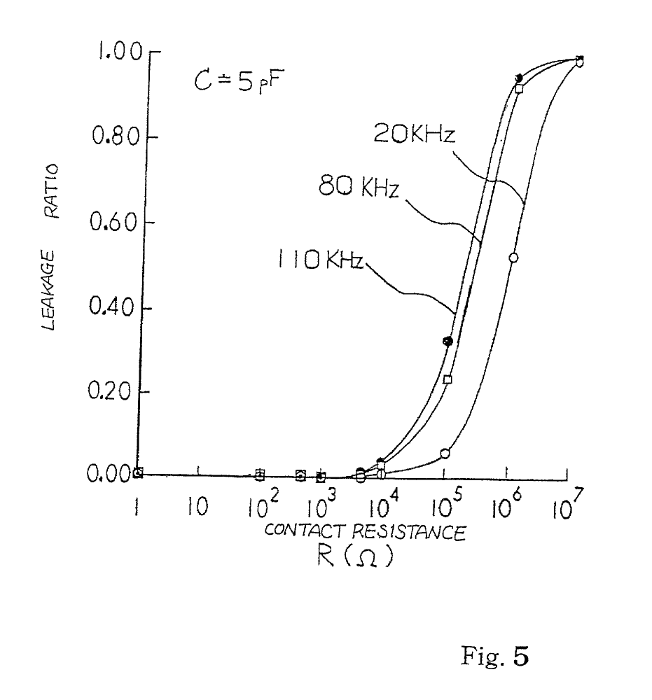

Generally, the electrostatic capacitance C was about 5 pF and the frequency f was selected from the range between 20 kHz and 110 kHz. The present inventor determined the leakage ratio LR on the assumption that the electrostatic capacitance C was 5 pF and that the frequency was 20 kHz, 80 kHz and 110 kHz. The contact resistance R was varied from 1 ohm through 100 ohms 500 ohms, 1 kilo-ohms, 5 kilo-ohms, 10 kilo-ohms, 100 kilo-ohms and 1 mega-ohms to 10 mega-ohms. Moreover, the present inventor observed the electron beams to see whether or not the deviation of convergence took place. The experimental result was summarized in Table 1 and plotted in FIG. 5.

TABLE 1

| | f = 20 kHz | | f = 80 kHz | | f = 110 kHz | |
|---|---|---|---|---|---|---|
| | | Devia- | | Devia- | | Devia- |
| | | tion of | | tion of | | tion of |
| Contact | Leakage | Conver- | Leakage | Conver- | Leakage | Conver- |
| Resistance | Ratio | gence | Ratio | gence | Ratio | gence |
| 1 ohm | 0.00 | Not | 0.00 | Not | 0.00 | Not |
| | | Problem | | Problem | | Problem |
| 100 ohms | 0.00 | Not | 0.00 | Not | 0.00 | Not |
| | | Problem | | Problem | | Problem |
| 500 ohms | 0.00 | Not | 0.00 | Not | 0.00 | Not |
| | | Problem | | Problem | | Problem |
| 1 kilo-ohms | 0.00 | Not | 0.00 | Not | 0.00 | Not |
| | | Problem | | Problem | | Problem |
| 5 kilo-ohms | 0.00 | Not | 0.01 | Problem | 0.02 | Problem |
| | | Problem | | | | |
| 10 kilo-ohms | 0.01 | Problem | 0.03 | Problem | 0.04 | Problem |
| 100 kilo-ohms | 0.06 | Problem | 0.24 | Problem | 0.33 | Problem |
| 1 mega-ohms | 0.53 | Problem | 0.93 | Problem | 0.96 | Problem |
| 10 mega-ohms | 0.99 | Problem | 1.00 | Problem | 1.00 | Problem |

Thus, the influence of parabola voltage was ignorable between 20 kHz and 110 kHz in so far as the contact resistance was equal to or less than 1 kilo-ohms. In other words, when the contact resistance R was equal to or less than 1 kilo-ohms in the frequency range between 20 kHz and 110 kHz, any light was not emitted from unexpected fluorescent dots. This meant that the deviation of convergence did not take place inside the color picture tube.

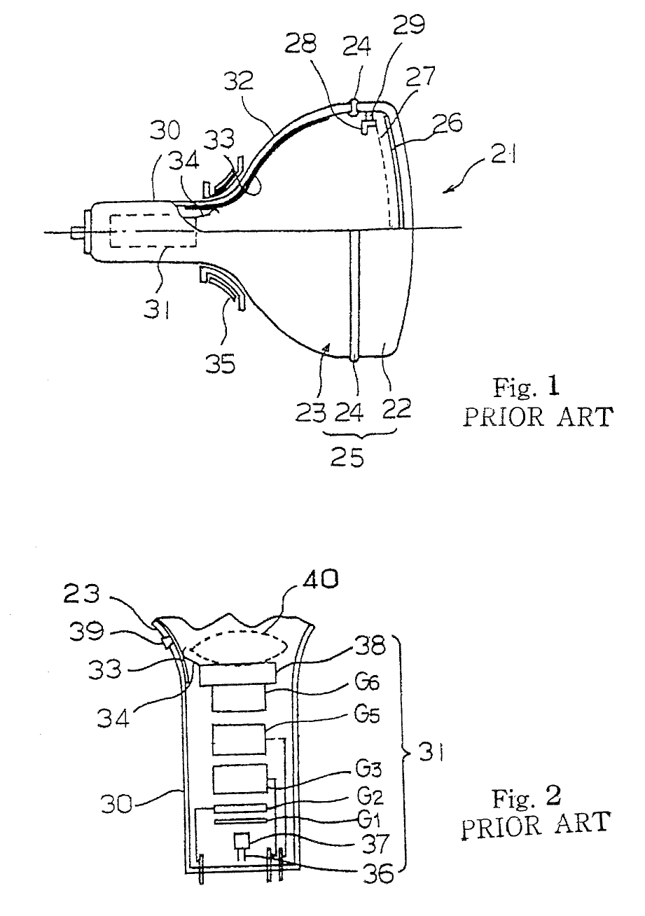

The deviation of convergence is derived from the results of the experiment as follows. Turning back to FIGS. 1 and 2, the high voltage is supplied through the high voltage input terminal 39 to the conductive layer 33, and is applied to the shield case 38 and the accelerating electrode G6 through the bulb spacer 34. When the high voltage passes through the contact between the conductive layer 33 and the bulb spacer 34, the high voltage is dropped due to the contact resistance R. A main lens is produced by the accelerating electrode G6 and the focusing electrode G5. However, the voltage level applied to the main lens is lower than the target voltage. The parabola voltage is applied to the focusing electrode G5, and is leaked from the focusing electrode G5 to the accelerating electrode G6 due to the electrostatic capacitance between the focusing electrode G5 and the accelerating electrode G6 and the contact resistance R between the conductive layer 33 and the bulb spacer 34. This results in a potential difference between the shield case 38 and the conductive layer 33. The potential difference is equal to the voltage VR shown in equation (4). The parabola voltage component, i.e., VR is superimposed on the direct current high voltage supplied to the accelerating electrode G6. Thus, the voltage at the accelerating electrode G6 is varied together with the parabola voltage. Then, an undesirable quasi lens 40 is produced in front of the shield case 38, and is deformed in synchronism with the parabola voltage. The electron beams are deflected by means of the quasi lens 40. Especially, the side electron beams are widely deflected rather than the central electron beam. As a result, the electron beams reach unexpected fluorescent dots, the undesirable light is emitted therefrom, and the deviation of convergence takes place in synchronism with the parabola voltage.

As described hereinbefore, the reduction of the contact resistance R is effective against the deviation of convergence. In order to reduce the contact resistance R, the following approaches are effective.

(1) optimizing the thickness of the conductive layer,

(2) forming the conductive layer by using low-resistive material,

(3) optimizing the conditions of the knocking for preventing the conductive layer of the bulb spacer from damage. The reason for the third approach was that damage to the conductive layer and the degradation thereof was causative of large contact resistance. While the conductive components inside the bulb were being subjected to the knocking, discharging current flew from the electron gun assembly toward the high voltage input terminal. The current gave rise to Joule heat generation at the contact between the bulb spacer and the conductive layer. The conductive layer was liable to be damaged and degraded due to the Joule heat. The damaged/degraded conductive layer exhibited a large resistance against the current.

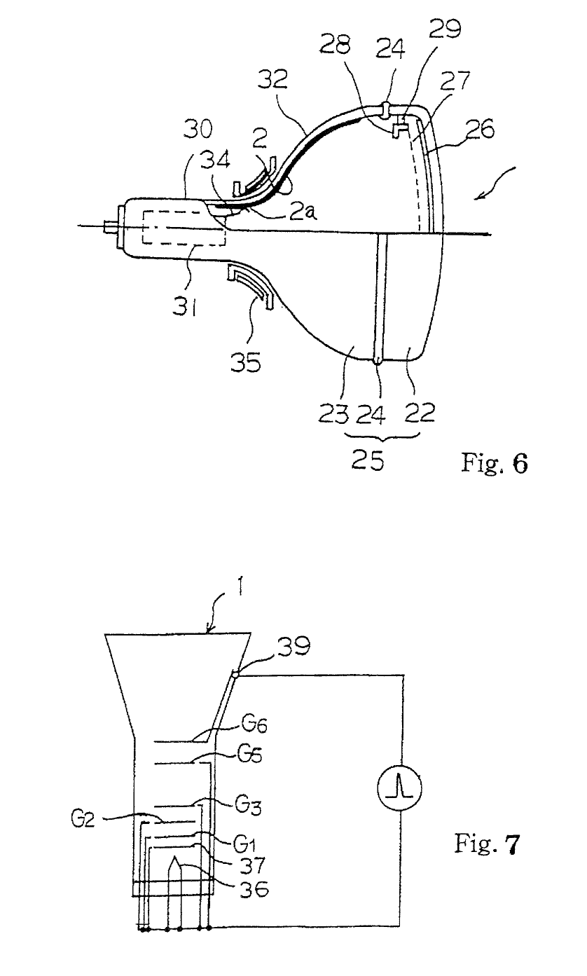

Referring to FIG. 6 of the drawings, a color picture tube embodying the present invention is designated by reference numeral (1). The contact resistance is equal to or less than 1 kilo-ohms in the color picture tube 1.

The color picture tube 1 largely comprises a bulb 25, an electron gun assembly 31, a deflecting yoke 35, a conductive layer 2 and a bulb spacer 34. The bulb 25 is splittable into a face panel 22 and a funnel 23. The face panel 22 is formed of glass, and the funnel 23 is also formed of glass. The funnel 23 is partially constant in cross section, and the cross section is gradually increased. The portion which is constant in cross section is called as a neck portion 30, and the remaining portion, which is gradually increased in cross section, is a cone portion 32. The face panel 22 is aligned with the cone portion 32 of the funnel 23, and the face panel 22 and the funnel 23 are assembled together by means of glass frit 24. Then, a hollow space is defined inside of the bulb 25.

The color picture tube 1 further includes a fluorescent screen 26 and a shadow mask structure, and the shadow mask structure includes a shadow mask 27 and a mask frame 28. Florescent dots for red light, fluorescent dots for green light and fluorescent dots for blue light are arranged on the fluorescent screen 26, and a large number of through-holes are formed in the shadow mask 27. The three kinds of fluorescent substance may be formed into stripes on the fluorescent screen 26. The shadow mask 27 is spaced from the fluorescent screen 26 by a predetermined distance, and is welded to the mask frame 28. The mask frame 28 is assembled with the glass face panel 22 by means of pins 29. The deflecting yoke 35 is attached to the funnel 23 at the boundary between the neck portion 30 and the cone portion 32.

The electron gun assembly 31 is accommodated in the neck portion 31, and is directed to the fluorescent screen 26. The electron gun assembly 31 is similar in structure to that of the prior art electron gun assembly shown in FIG. 2, and the first, second, third, fifth and sixth electrodes G1, G2, G3, G5 and G6, a heater 36, cathode 37 and a shield case 38 are arranged in the electron gun assembly 31. The fifth electrode G5 and the sixth electrode G6 serve as a focusing electrode and an accelerating electrode, respectively.

A conductive layer 2 is formed on the inner surface of the funnel 23. The conductive layer 2 extends from the cone portion 32 toward the neck portion 30. The conductive layer 2 passes through the deflecting yoke 35, and reaches the region in the vicinity of the electron gun assembly 31. The bulb spacer 34 is connected at one end thereof to the shield case 38, and is held in contact with a contact portion 2a of the conductive layer 2 at the other end thereof The contact resistance R between the conductive layer 2 and the bulb spacer 34 is equal to or less than 1 kilo-ohms.

In order to reduce the contact resistance R to 1 kilo-ohms or less, at least the contact portion 2a is regulated to be equal to or greater than 5 microns thick. Of course, the portion in the vicinity of the contact portion is as thick as the contact portion 2a. The thickness of the conductive layer 2 is to be fallen within the range from 5 microns to 10 microns and, more preferably, from 7 microns to 10 microns. The reason for the thickness range will be described hereinlater in detail.

The conductive layer 2 contains conductive powder and binder. A small amount of stiffener may be added in order to increase the mechanical strength of the conductive layer. The conductive powder is composed of graphite. The stiffener contains titanium oxide, iron oxide and so forth. Potassium silicate, sodium and so forth silicate are used as the binder.

The conductive layer 2 is formed as follows. First, conductive coating paste is prepared. The conductive coating paste is put into a coating system (not shown). A nozzle (not shown) is directed to the inner surface of the bulb 25, and the conductive coating paste is sprayed onto the inner surface. The conductive coating past forms a layer on the inner surface, and is dried. Then, the conductive layer 2 is formed on the inner surface of the bulb 25.

The color picture tube according to the present invention is fabricated through a process described hereinbelow. First, the face panel 22 and the funnel 23 are prepared. The fluorescent screen 26 and the shadow mask structure 27/28 are assembled with the face panel 22, and the conductive layer 2 is formed on the inner surface of the funnel 23 as described hereinbefore The face panel 22 and the funnel 23 are assembled into the bulb 25 by means of the glass frit 24.

Subsequently, the electron gun assembly 31 and, accordingly, the bulb spacer 34 are inserted into the bulb 25. The bulb spacer 34 is held in contact with the contact portion 2a of the conductive layer 2. The electron gun assembly 31 is fixed to the bulb 25.

Subsequently, the bulb 25 is connected to an evacuation system (not shown) at an evacuation port thereof The bulb 25 is heated, and the gas is evacuated from the inner space of the bulb 25. The outgassing from the electrodes, the decomposition of carbonate of alkaline earth metal, which was coated on the cathode 37, and the melt-down of the evacuation port are carried out in the latter stage of the evacuation. Thus, the electron gun assembly 31, the bulb spacer 34, the conductive layer 2, the shadow mask structure 27/28 and the fluorescent screen 26 are sealed in the inner space of the bulb 25.

Subsequently, a gettering layer is formed, the cathode is stabilized, and the knocking is carried out. FIG. 7 shows an electrical connection for the knocking. A high voltage is, by way of example, applied between the focusing electrode G5 and the accelerating electrode. Then, the focusing electrode G5 and the accelerating electrode G6 sparks so as to make the rough surfaces flat and remove burrs therefrom. A source of stray-emission such as barium compound is eliminated from the electrodes. The knocking is carried out under the same conditions as those of the prior art knocking. If the knocking is carried out on the gentle conditions, the electrodes are less damaged in the knocking, and the bulb spacer 34 and the conductive layer 2 keep the constant resistance R low.

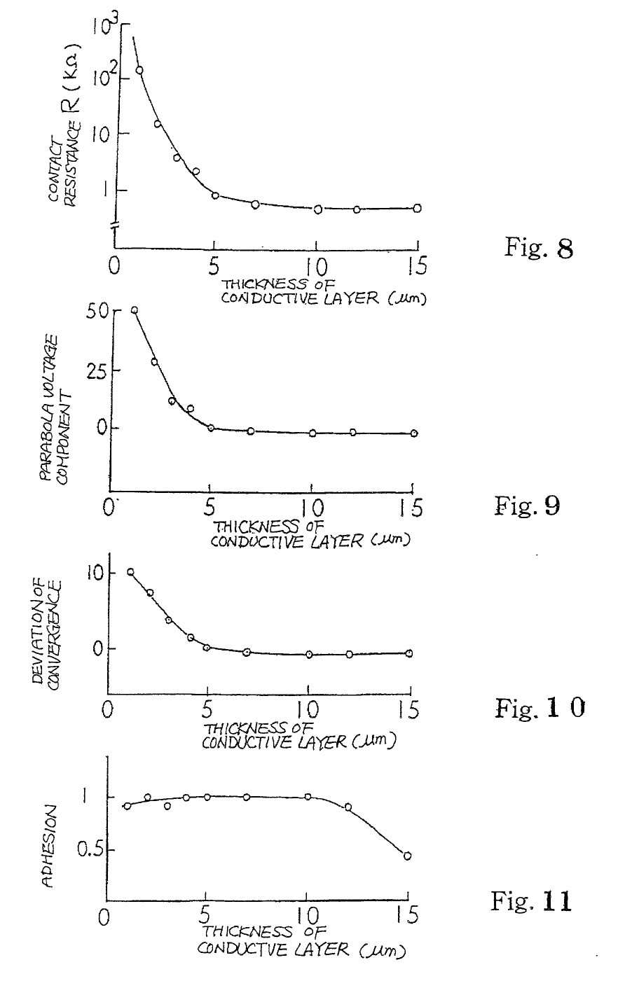

The present inventor evaluated the conductive layer 2 as follows. The present inventor fabricated samples of the color picture tube through the process described hereinbefore. The samples respectively had the conductive layers 2 different in thickness. The present inventor measured the contact resistance R, the parabola voltage component superimposed on the high voltage at the accelerating electrode G6, deviation of convergence and the adhesion between the inner surface of the bulb 25 and the conductive layer 2, and plotted in fIGS. 8 to 11. The parabola voltage component, the deviation of convergence and the adhesion were represented by relative values, and, accordingly, the unit was arbitrary.

The samples which had the conductive layers 2 less than 5 microns thick exhibited the contact resistance greater than 1 kilo-ohms, and, accordingly, the contact resistance R equal to or less than 1 kilo-ohms was achieved by the samples having the conductive layers 2 equal to or greater than 5 microns thick (see FIG. 8). Thus, the minimum thickness was 5 microns. The large contact resistance may be due to the degradation or the damage. In the case that the conductive layer 2 is equal to or greater than 5 microns thick, even if the knocking is carried out under the same conditions as those of the prior art knocking, the contact resistance is kept 1 kilo-ohms or less, and then the contact portion 2a is prevented from damage.

In the samples which had the conductive layers 2 less than 5 microns thick, the parabola voltage component was rapidly increased inversely proportional to the thickness. On the other hand, the samples which had the conductive layers 2 equal to or greater than 5 microns thick were free from the influence of the parabola voltage, and, accordingly, the parabola voltage component was zero.

Accordingly, the deviation of convergence was not observed in the samples which had the conductive layers 2 equal to or greater than 5 microns thick. However, the deviation of convergence became serious inversely proportional to the thickness of the conductive layer 2.

The adhesion was constant in the samples which had the conductive layers 2 equal to or less than 10 microns thick. However, when the conductive layer 2 exceeded 10 microns thick, the adhesion was reduced. This meant that the conductive layer 2 was liable to peel off from the inner surface of the bulb 25. If the conductive layer 2 peeled off, short- circuit took place between the electrodes, and certain holes formed in the shadow mask 27 were masked by the small peeled pieces. Thus, the peeling was not desirable. In order to suppress the peeling, the conductive layer 2 was to be equal to or less than 10 microns thick. For this reason, the present inventor set the upper limit to the thickness range.

It was understood from the above-described experiments, the conductive layer 2 was to be fallen within the range between 5 microns thick and 10 microns thick. When taking the aged deterioration and margin into account, the thickness range between 7 microns and 10 microns was more desirable.

As will be appreciated from the foregoing description, the bulb spacer 34 is to be held in contact with the conductive layer 2 at 1 kilo-ohms or less. The small contact resistance prevents the accelerating electrode from the influence of the parabola voltage applied to the focusing electrode, and the quasi lens 40 is undesirably deformed. Thus, the small contact resistance is effective against the deviation of convergence.

Although particular embodiments of the present invention have been shown and described, it will be apparent to those skilled in the art that various changes and modifications may be made without departing from the spirit and scope of the present invention.

What is claimed is:

1. A color picture tube for producing visual images, comprising:
a bulb having an inner space;
a fluorescent screen attached to said bulb, and producing said visual image;
a shadow mask structure provided in said inner space, having plural through holes, and inwardly spaced from said fluorescent screen;
an electron gun assembly radiating electron beams through said plural through-holes to said fluorescent screen, and including at least a focusing electrode applied with an alternating current voltage and an accelerating electrode;
a bulb spacer connected at one end thereof to said accelerating electrode; and
a conductive layer formed on an inner surface of said bulb, and connected to another end of said bulb spacer for supplying said high voltage to said accelerating electrode through said bulb spacer against a contact resistance equal to or less than 1 kilo-ohms.

2. The color picture tube as set forth in claim 1, in which said conductive layer has a thickness equal to or greater than 5 microns.

3. The color picture tube as set forth in claim 2, in which said thickness of said conductive layer is equal to or less than 10 microns.

4. The color picture tube as set forth in claim 3, in which said conductive layer contains conductive material composed of graphite.

5. The color picture tube as set forth in claim 4, in which said conductive layer further contains at least one substance selected from the group consisting of titanium oxide and iron oxide.

6. The color picture tube as set forth in claim 5, in which said conductive layer further contains a binder.

7. The color picture tube as set forth in claim 6, in which said binder is selected from the group consisting of potassium silicate and sodium silicate.

8. The color picture tube as set forth in claim 1, in which said conductive layer has a thickness fallen within the range between 7 microns to 10 microns.

9. The color picture tube as set forth in claim 8, in which said conductive layer contains conductive material composed of graphite.

10. The color picture tube as set forth in claim 9, in which said conductive layer further contains at least one substance selected from the group consisting of titanium oxide and iron oxide.

11. The color picture tube as set forth in claim 10, in which said conductive layer further contains a binder.

12. The color picture tube as set forth in claim 11, in which said binder is selected from the group consisting of potassium silicate and sodium silicate.

13. The color picture tube as set forth in claim 1, in which said focusing electrode and said accelerating electrode have relatively smooth surfaces created through a knocking under the conditions less damaging and deteriorating said focusing electrode and said accelerating electrode.

14. The color picture tube as set forth in claim 12, said conductive layer having a thickness equal to or greater than 5 microns.

15. The color picture tube as set forth in claim 14, in which said thickness of said conductive layer is equal to or less than 10 microns.

16. The color picture tube as set forth in claim 15, in which said conductive layer contains conductive material composed of graphite.

17. The color picture tube as set forth in claim 16, in which said conductive layer further contains at least one substance selected from the group consisting of titanium oxide and iron oxide.

18. The color picture tube as set forth in claim 17, in which said conductive layer further contains a binder.

19. The color picture tube as set forth in claim 18, in which said binder is selected from the group consisting of potassium silicate and sodium silicate.
